(19) United States
(12) Patent Application Publication
(10) Pub. No.: US 2012/0106527 A1
(43) Pub. Date: May 3, 2012

(54) WIRELESS LAN SYSTEM, COMMUNICATION DEVICE AND METHOD OF SHARING SETTING INFORMATION

(75) Inventors: Goki ICHIKAWA, Nagoya-shi (JP); Kota Sato, Nagoya-shi (JP)

(73) Assignee: Buffalo Inc., Nagoya-shi (JP)

(21) Appl. No.: 13/274,928

(22) Filed: Oct. 17, 2011

(30) Foreign Application Priority Data
Oct. 29, 2010 (JP) 2010-243237

(51) Int. Cl. H04W 84/02

(52) U.S. Cl. 370/338

(57) ABSTRACT

A communication device configured to enable a setting process, performed with another communication device, for sharing setting information including information for settings of wireless communication to another communication device. The communication device includes a wireless LAN interface, a first wired connector, and an execution module that controls wireless communication with the another communication device and performs the first communication device's operation of the setting process when a second wired connector of the another communication device is connected to the first wired connector.

### CROSS-REFERENCE TO RELATED APPLICATION

This application claims the priority based on Japanese Patent Application No. 2010-243237 filed on Oct. 29, 2010, the disclosure of which is hereby incorporated by reference in its entirety.

### BACKGROUND

1. Technical Field

This invention relates to technology for sharing setting information between communication devices for making wireless LAN communication.

2. Related Art

Recently, wireless LANs have been widely used. In wireless LAN, communication devices for making communication share the setting information for settings of wireless communication. For example, when a wireless LAN is made conforming to the IEEE802.11 standard, at least SSID (Service Set Identifier) is shared between communication devices. For encrypted communication, information, such as an encryption method and an encryption key, is shared between communication devices.

For example, AOSS (AirStation One-Touch Secure System: registered trademark by Buffalo Inc.) and WPS (Wi-Fi Protected Setup) are known as the technology for readily sharing such setting information. According to such technology, when the user gives a specified instruction to an access point and a station by pushing a button or by accessing a WEB setting window via a WEB browser, wireless communication is made between the access point and the station to share the setting information. This improves the user's convenience, compared with the user's manual input of the setting information. For a person poorly informed of communication technology, however, it is not easy to give the specified instruction to the access point and the station, so that there is still room for improvement.

Consequently, there is a need to improve the user's convenience for communication setting for a wireless LAN.

### SUMMARY

According to one aspect of the invention, there is provided a wireless LAN system comprising: a first communication device having a first wired connector; and a second communication device having a second wired connector connectable with the first wired connector, and being configured to enable a setting process, performed between the first communication device and the second communication device, for sharing setting information including information for settings of wireless communication. The first communication device comprises; a first wireless LAN interface for making the wireless communication; and a first execution module for making the wireless communication with the second communication device and performing a first operation as one relevant entity's operation of the setting process, when the second wired connector is connected to the first wired connector. The second communication device comprises; a second wireless LAN interface for making the wireless communication; and a second execution module for making the wireless communication with the first communication device and performing a second operation as the other relevant entity's operation of the setting process, when the first wired connector is connected to the second wired connector. In the wireless LAN system according to this aspect, it is possible to perform the setting process between the first communication device and the second communication device and automatically share the setting information between the first communication device and the second communication device, only when the user connects the second communication device with the active first communication device. In other words, it is possible to achieve the automatic communication setting by only requiring the user to make connection between the first communication device and the second communication device, thus improving the user's convenience for communication setting.

In the wireless LAN system, the first wired connector may be a power socket, and the second wired connector may be a power plug. Additionally, the first communication device may further comprise: a power input module for receiving input of power supply as power of the first communication device; a power output module with the power socket for outputting power to the second communication device via the power socket; and a detection module for detecting connection of the power plug to the power socket. The first execution module may perform the first operation when the connection of the power plug to the power socket is detected, and the second execution module may perform the second operation when the second communication device is activated with power received from the power output module via the power socket. According to this feature, it is possible to perform the setting process between the first communication device and the second communication device and automatically share the setting information between the first communication device and the second communication device, only when the user connects the second communication device with the active first communication device to activate the second communication device. In other words, it is possible to achieve the automatic communication setting by only requiring the user to make connection between the first communication device and the second communication device, thus improving the user's convenience for communication setting.

In the wireless LAN system, the second execution module may send an association request for establishing a connection for the wireless communication to the first communication device, before performing the second operation. The first communication device may further comprise a first prohibition module for prohibiting completion of the first operation with a source of the association request, which is received by the first communication device, as the other relevant entity of the setting process, when received signal strength indication of the received association request is not within a preset range. When the setting process is performed between the first communication device and the second communication device, the first communication device and the second communication device are located at proximate relative positions due to their connection configuration, so that there is little distance attenuation of the received signal strength indication of the association request and there is little variation in received signal strength indication caused by the difference in distance. For this reason, it can be checked whether the source of the association request is the communication device connected to the power output module, according to the received signal strength indication of the association request. By utilizing this feature, the first communication device receives the association request and prohibits completion of the first operation with the source of the received association request, when the received signal strength indication of the received association request is not within the preset range, so that it is possible to suppress completion of the setting process with a communication device placed at a location away by at least a predetermined distance, i.e., a communication device that is not connected with the power output module. As the result, it is possible to suppress the setting information from being shared between the first communication device and the user's unintended communication device.

In the wireless LAN system, the first communication device may further comprise a first output control module for controlling transmission output level of the wireless communication made via the first wireless LAN interface. The first output control module may set lower transmission output level than an output level during ordinary communication for making data communication with the second communication device, when the first communication device performs wireless communication as the first operation. In the wireless LAN system according to this feature, the first communication device performs the wireless communication as the first operation with reducing the transmission output level from the output level during ordinary communication, so as to limit the signal coverage of the wireless communication for the setting process. Accordingly, it is possible to suppress the setting process from being performed with a communication device placed at a location away by at least a predetermined distance, i.e., a communication device that is not connected with the power output module. As the result, it is possible to suppress the setting information from being shared between the first communication device and the user's unintended communication device.

In the wireless LAN system, the first output control module may reset the transmission output level of the first communication device to the output level during ordinary communication, at timing when at least one of the first communication device and the second communication device sharing the setting information is expected to be moved to an intended location. In the wireless LAN system according to this feature, even when the user moves the first communication device or the second communication device to an intended location after sharing of the setting information to make a relatively large distance between the first communication device and the second communication device, the first communication device can send communication packets to the second communication device at the adequate communicable transmission output level.

In the wireless LAN system, the second communication device may further comprise a second output control module for controlling transmission output level of the wireless communication made via the second wireless LAN interface. The second output control module may set the transmission output level than an output level during ordinary communication for making data communication with the first communication device, when the second communication device performs wireless communication as the second operation. In the wireless LAN system according to this feature, the second communication device performs the wireless communication as the second operation with reducing the transmission output level from the output level during ordinary communication, so as to limit the signal coverage of the wireless communication for the setting process. Accordingly, it is possible to suppress the setting process from being performed with a communication device placed at a location away by at least a predetermined distance, i.e., a communication device other than the first communication device. As the result, it is possible to suppress the setting information from being shared between the second communication device and the user's unintended communication device.

In the wireless LAN system, the second output control module may reset the transmission output level of the second communication device to the output level during ordinary communication, at timing when at least one of the first communication device and the second communication device sharing the setting information is expected to be moved to an intended location. In the wireless LAN system according to this feature, even when the user moves the first communication device or the second communication device to an intended location after sharing of the setting information to make a relatively large distance between the first communication device and the second communication device, the second communication device can send communication packets to the first communication device at the adequate communicable transmission output level.

In the wireless LAN system, the first communication device may further comprise a notification module for sending a notification frame for notifying presence of the first communication device, before performing the first operation. The second communication device may further comprise a second prohibition module for prohibiting completion of the second operation with a source of the notification frame, which is received by the second communication device, as one relevant entity of the setting process, when received signal strength indication of the received notification frame is not within a preset range. In the wireless LAN system according to this feature, like the association request described above, there is little distance attenuation of the received signal strength indication of the notification frame and there is little variation in received signal strength indication caused by the difference in distance. For this reason, it can be checked whether the source of the notification frame is the first communication device, according to the received signal strength indication of the notification frame. By utilizing this feature, the second communication device receives the notification frame and prohibits completion of the second operation with the source of the received notification frame, when the received signal strength indication of the received notification frame is not within the preset range, so that it is possible to suppress completion of the setting process with a communication device placed at a location away by at least a predetermined distance, i.e., a communication device other than the first communication device. As the result, it is possible to suppress the setting information from being shared between the second communication device and the user's unintended communication device.

In the wireless LAN system, the notification module may send the notification frame including specified identification information. The second prohibition module may prohibit completion of the second operation with the source of the received notification frame as the one relevant entity of the setting process, when the received notification frame does not include the identification information even when the received signal strength indication of the received notification frame is within the preset range. In the wireless LAN system according to this feature, it is possible to suppress the setting information from being shared between the second communication device and a communication device other than the relevant entity of the setting process, even when the communication device placed at a location proximate to the second communication device sends a notification frame. As the result, it is possible to suppress the setting information from being shared between the second communication device and the user's unintended communication device.

The invention is not limited to the aspect of the wireless LAN system described above but may be actualized by various other aspects, for example, the communication device, a method of sharing the setting information, a program performed by the communication device and a non-transitory computer-readable storage medium in which the program is recorded. Any of the above features may obviously be added to any of these aspects.

### BRIEF DESCRIPTION OF THE DRAWINGS

FIG. 1 is an explanatory diagram showing the general configuration of a wireless LAN system 20 according to one embodiment of the invention;

FIG. 2 is an explanatory diagram showing the general structure of an access point AP;

FIG. 3 is an explanatory diagram showing the general structure of a wireless station STA;

FIG. 4 is an explanatory diagram showing connection between the access point AP and the wireless station STA in an automatic setting operation;

FIG. 5 is a flowchart showing the flow of automatic setting operation performed at the access point AP; and

FIG. 6 is a flowchart showing the flow of automatic setting operation performed at the wireless station STA.

### DESCRIPTION OF THE PREFERRED EMBODIMENTS

### A. Embodiment

### A-1. General Configuration of Wireless LAN System 20

Embodiments of the invention are described below.

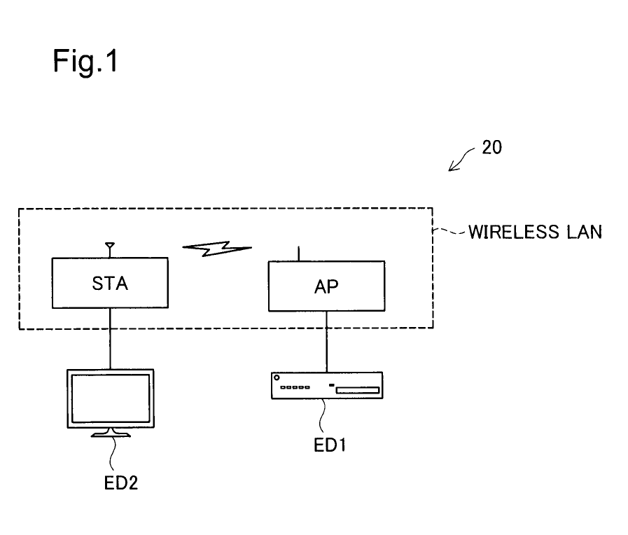

FIG. 1 is an explanatory diagram showing the general configuration of a wireless LAN system 20 according to one embodiment of the invention.

The wireless LAN system 20 includes an access point AP and a wireless station STA. A wireless LAN is established between the access point AP and the wireless station STA. The access point AP has access point function for relaying communication between stations and bridging function for interconnecting a wired LAN with a wireless LAN. This access point AP corresponds to the first communication device of the claims. The wireless station STA is a so-called Ethernet converter (wherein Ethernet is registered trademark) having station function and bridging function for interconnecting a wired LAN with a wireless LAN. This wireless station STA corresponds to the second communication device of the claims.

The access point AP has one wired LAN port, to which an electronic device ED1 having a wired LAN port is connected via a wired LAN cable. The electronic device ED1 is a network-ready Blu-ray player in this embodiment. The wireless station STA has one wired LAN port, to which an electronic device ED2 having a wired LAN port is connected via a wired LAN cable. The electronic device ED2 is a network-ready TV set in this embodiment.

In this wireless LAN system 20, the access point AP and the wireless station STA make wireless communication in infrastructure mode to allow for communication between the electronic device ED1 and the electronic device ED2. For example, the user can view video data reproduced by the electronic device ED1 and displayed on the electronic device ED2.

The network configuration of the wireless LAN system 20 described above is only illustrative and may include plural wireless stations STA and access points AP. The access point AP and the wireless station STA may also have plural wired LAN ports or may not have a wired LAN port. Additionally, the access point AP may be connected with an external network, for example, via a router or may be connected with plural wireless stations. The wireless LAN system 20 only needs to include a communication device having at least the access point function and a communication device having at least the station function.

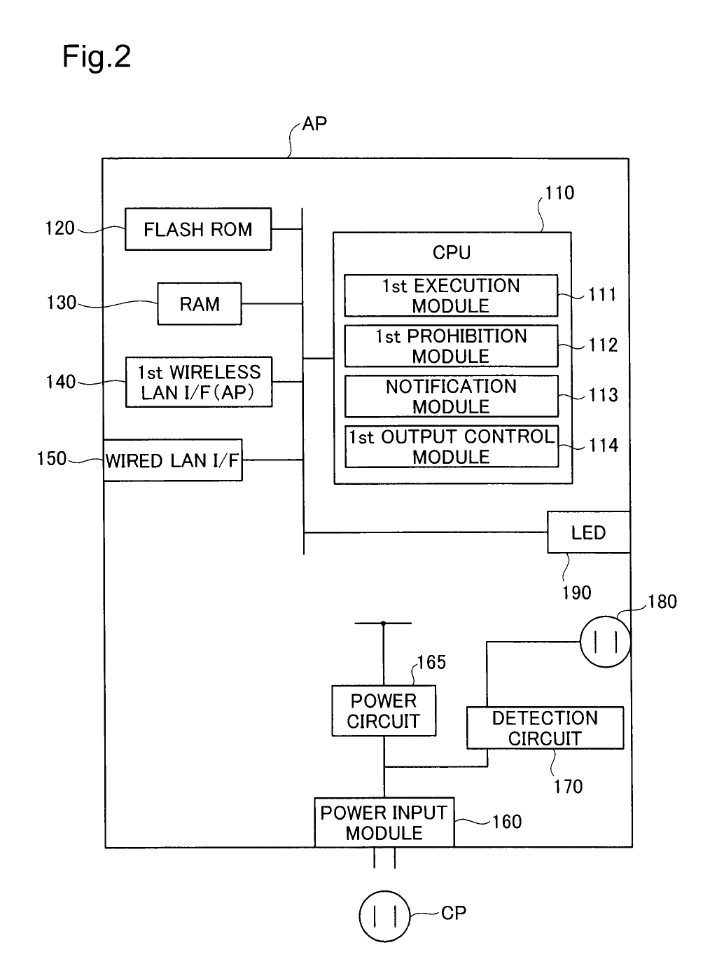

The general structure of the access point AP included in the wireless LAN system 20 is shown in FIG. 2. As illustrated, the access point AP includes a CPU 110, a flash ROM 120, a RAM 130, a first wireless LAN interface 140, a wired LAN interface 150, a power input module 160, a power circuit 165, a detection circuit 170, a power output module 180 and an LED 190.

The CPU 110 loads and performs a program, such as firmware, which is stored in the flash ROM 120, on the RAM 130 to control the general operations of the access point AP. The CPU 110 also performs a predetermined program to function as a first execution module 111, a first prohibition module 112, a notification module 113 and a first output control module 114. The functions of the first execution module 111 include automatic setting function for performing asymmetric processing by the access point and the station and automatically sharing the setting information for settings of wireless communication. The details of these functional modules will be described later.

The first wireless LAN interface 140 is a control circuit for making wireless communication conforming to the wireless LAN standard and includes hardware such as a modulator, an amplifier and an antenna. The first wireless LAN interface 140 is built in the access point AP in the state allowing for transmission of outbound signals and reception of inbound signals. In this embodiment, the first wireless LAN interface 140 is configured conforming to the IEEE802.11 standard. The first wireless LAN interface 140 may be controlled by the CPU 110 to virtually function as two logic devices, i.e., access point and station, simultaneously or to selectively and exclusively function as one of the logic devices, i.e., access point or station, at any arbitrary time.

The wired LAN interface 150 is an interface for connecting with a wired LAN. In this embodiment, the wired LAN interface 150 conforms to the IEEE802.3 standard. This wired LAN interface 150 has one wired port and is connected with the electronic device ED1.

The power input module 160 is a power connector having a power plug. This power input module 160 is connected to a socket for commercial power source CP to receive power for the access point AP. This power input module 160 is connected with the power circuit 165. The power circuit 165 includes an AC-DC converter to convert AC power received by the power input module 160 to DC power, drops the voltage of the DC power to a preset voltage level and supplies the dropped voltage to the respective parts of the access point AP. Alternatively the power input module 160 may be configured to receive DC power via an AC adaptor for converting AC power to DC power. The power source is, however, not specifically limited, but the output of fuel cells or solar cells, for example, may be used instead of the commercial power source.

The power input module 160 is also connected with the power output module 180. The power output module 180 is a service socket for externally outputting the power received by the power input module 160. The detection circuit 170 is connected to a power line of interconnecting the power input module 160 and the power output module 180 to detect connection of a power plug of another device to the power output module 180 and output the detection result to the CPU 110. In this embodiment, the detection circuit 170 is a current sensor and is configured to monitor the electric current flowing to a device connected to the power output module 180 and thereby detect connection of another device to the power output module 180. The method of detecting connection is, however, not specifically limited but may be mechanical detection or optical detection, instead of electrical detection. For example, the detection of connection may detect the push of a button, which is protruded from the power output module 180, by the connection of another device to the power output module 180 or may use a photo interrupter.

The LED 190 serves as module for notifying the operation status of the access point AP during automatic setting operation described later. In this embodiment, when the automatic setting operation starts, the CPU 110 lights up the LED 190 in red. When providing the wireless station STA with setting information by the automatic setting operation and receiving completion notice of setting the setting information from the wireless station STA, the CPU 110 lights up the LED 190 in green. The notifying method is, however, not specifically limited, but the above two operation statuses may be notified by flashing and lighting. The notification module is not limited to emission of light but may be text display on a display module.

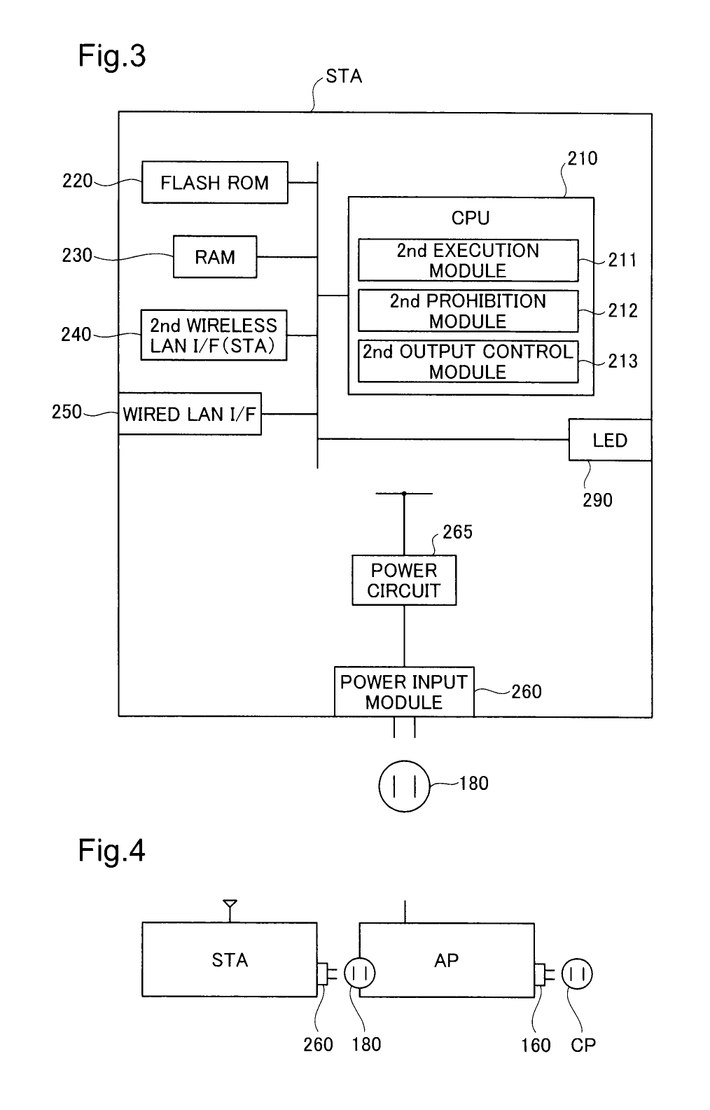

The general structure of the wireless station STA included in the wireless LAN system 20 is shown in FIG. 3. As illustrated, the wireless station STA includes a CPU 210, a flash ROM 220, a RAM 230, a second wireless LAN interface 240, a wired LAN interface 250, a power input module 260, a power circuit 265 and an LED 290.

The CPU 210 loads and performs a program, such as firmware, which is stored in the flash ROM 220, on the RAM 230 to control the general operations of the wireless station STA. The CPU 210 also performs a predetermined program to function as a second execution module 211, a second prohibition module 212 and a second output control module 213. The functions of the second execution module 211 include automatic setting function for automatically setting the setting information for wireless communication with the access point AP. The details of these functional modules will be described later.

The second wireless LAN interface 240 is an interface as the station. This second wireless LAN interface 240 is a control circuit for making wireless communication conforming to the wireless LAN standard and includes hardware such as a modulator, an amplifier and an antenna. The second wireless LAN interface 240 is built in the wireless station STA in the state allowing for transmission of outbound signals and reception of inbound signals. In this embodiment, the second wireless LAN interface 240 is configured conforming to the IEEE802.11 standard. The second wireless LAN interface 240 may be controlled by the CPU 210 to virtually function as two logic devices, i.e., access point and station, simultaneously or to selectively and exclusively function as one of the logic devices, i.e., access point or station, at any arbitrary time.

The wired LAN interface 250 is an interface for connecting with a wired LAN. In this embodiment, the wired LAN interface 250 conforms to the IEEE802.3 standard. This wired LAN interface 250 has one wired port and is connected with the electronic device ED2.

The power input module 260 is a power connector including a power plug, only which is protruded from the casing of the wireless station STA. This power input module 260 is connected to a socket for commercial power source to receive power for the wireless station STA. The power input module 260 may also be connected to the power output module 180 of the access point AP to receive the power for the wireless station STA. This power input module 260 is connected with the power circuit 265. The power circuit 265 includes an AC-DC converter to convert AC power received by the power input module 260 to DC power, drops the voltage of the DC power to a preset voltage level and supplies the chopped voltage to the respective parts of the wireless station STA. When the power input module 160 of the access point AP is configured to receive the DC power, the power input module 260 may also be configured to receive the DC power.

The LED 290 serves as module for notifying the operation status of the wireless station STA during the automatic setting operation described later. In this embodiment, when the automatic setting operation starts, the CPU 210 lights up the LED 290 in red. When the setting information has been set in the wireless station STA by the automatic setting operation, the CPU 210 lights up the LED 290 in green. This notification module may adopt any of various notifying methods, like the LED 190.

### A-2. Automatic Setting Operation

The automatic setting operation performed by the access point AP and the wireless station STA is described. The automatic setting operation herein means an AOSS-compliant operation for establishing the wireless LAN system 20 to send the setting information, which is to be shared by interconnecting wireless LAN devices, from the access point AP to the wireless station STA and automatically set the setting information in the wireless station STA. The automatic setting operation, however, differs from the standard AOSS operation in that the automatic setting operation does not require an AOSS start instruction (e.g., the push of a button). At the time of starting the automatic setting operation, the access point AP is in the active state with the power input module 160 of the access point AP connected to the socket for commercial power source CP, as shown in FIG. 4. When the power input module 260 of the wireless station STA is connected to the power output module 180 of the access point AP to supply power and activate the wireless station STA, the access point AP and the wireless station STA automatically recognize the respective other sides as pairing partners. The access point AP then automatically sets the setting information in the wireless station STA. The wireless station STA with the setting information set therein is once powered off, is placed at an intended location as shown in FIG. 1, and is again powered on to be used. In this embodiment, the setting information includes an ESSID (Extended Service Set Identifier), an encryption method and an encryption key (or information for generating the encryption key).

The automatic setting operation of this embodiment is described in detail below. The automatic setting operation is performed as asymmetric processing by the access point and the station, so that series of operations performed by the access point and series of operations performed by the station are explained separately.

### A-2-1. Automatic Setting Operation at Access Point

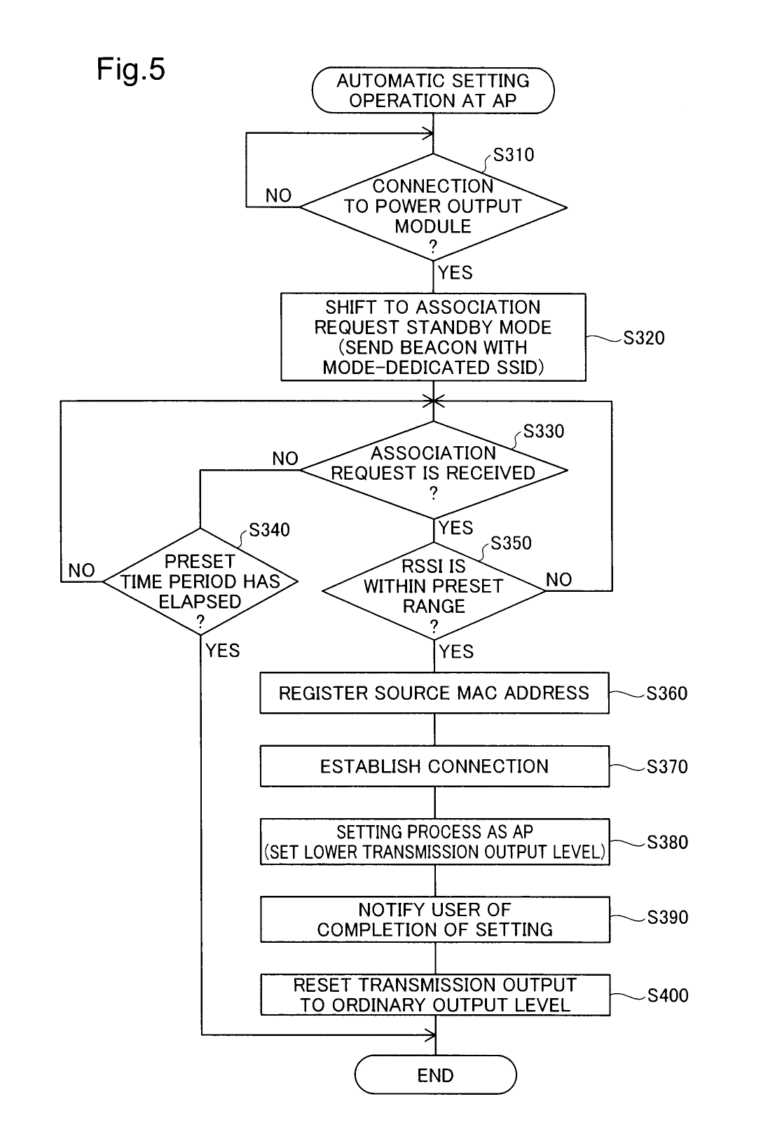

The automatic setting operation performed by the access point AP is explained. FIG. 5 shows the flow of automatic setting operation as the access point. In this embodiment, prior to start of the automatic setting operation, the access point AP is activated by connecting the power source to the power input module 160 of the access point AP. The CPU 110 of the access point AP waits until detection of the connection of a power plug of another device to the power output module 180 based on the output from the detection circuit 170 (step S310). Specifically, the CPU 110 stands by for connection of the wireless station STA to the power output module 180.

In response to detection of the connection (step S310: Yes), the CPU 110 starts the automatic setting operation on and after step S320. The CPU 110 first shifts from ordinary communication operation mode as the access point AP (i.e., data frame relay mode as the access point) to association request standby mode (step S320). In the association request standby mode, the CPU 110, as the process of its notification module 113, sends beacon via the first wireless LAN interface 140 at regular intervals, as in the ordinary communication operation mode. This beacon serves as a notification frame used by the access point AP to notify the other wireless LAN devices of the presence of the access point AP. The difference from the ordinary communication operation mode is that the association request standby mode sends beacon including an SSID dedicated to this mode (hereinafter also called dedicated SSID). The dedicated SSID serves as identification information showing that the access point AP is in execution standby status of the setting process described later. The notification frame is not limited to the beacon defined by the IEEE802.11 standard but may be sent according to a unique protocol. On the start of processing at step S320, the CPU 110 lights up the LED 190 in red.

When shifting to the association request standby mode, the CPU 110 checks whether an association request including a dedicated SSID to the association request standby mode is received (step S330). This association request may be sent, for example, by the wireless station STA at step S570 as described later. When the check result indicates no reception of an association request (step S330: No), the CPU 110 checks whether a preset time period has elapsed since the shift to the association request standby mode (step S340). When the check result indicates elapse of the preset time period (step S340: Yes), the CPU 110 terminates the automatic setting operation. When the check result indicates no elapse of the preset time period (step S340: No), on the other hand, the CPU 110 returns the processing to the above step S330.

When the check result indicates reception of an association request (step S330: Yes), on the other hand, the CPU 110 checks whether Received Signal Strength Indication (hereinafter also called RSSI) of the received association request is within a preset range (step S350). This identifies whether the received association request has been sent by the wireless station STA connected with the power output module 180, i.e., the wireless station STA as the pairing partner. Since the power input module 260 of the wireless station STA is connected with the power output module 180 of the access point AP, the wireless station STA and the access point AP have extremely proximate relative positions. Accordingly, there is extremely small distance attenuation of the RSSI in wireless communication between the access point AP and the wireless station STA, and there is little variation in RSSI caused by the difference in distance between the access point AP and the wireless station STA. When the transmission output level of association requests is fixed in advance to a predetermined value, the association requests sent by the wireless station STA connected with the power output module 180 have substantially constant RSSI values. Consequently, when the RSSI is in the preset range, it is identifiable with high accuracy that the received association request has been sent by the wireless station STA connected with the power output module 180.

In this embodiment, “within a preset range” means “not less than a preset value”. In other words, when the RSSI is not less than the preset value, it is identified that the received association request has been sent from the wireless station STA connected with the power output module 180. Even when the access point AP receives an association request sent by a station other than the wireless station STA, the received association request has greater distance attenuation than the association request sent by the wireless station STA and accordingly has relatively lower RSSI. The structure of the embodiment effectively prevents false recognition of the association request by any other station as the association request by the wireless station STA that is to be the pairing partner of the automatic setting operation. For example, even when a start instruction of the AOSS operation (e.g., the push of a button) is given to the user's unintended station located in signal coverage, for example, a third entity's station, immediately after the start of the automatic setting operation at the access point AP, the structure of the embodiment eliminates the association request sent by the third entity's station.

When the RSSI of the received association request is not within the preset range (step S350: No), this means that the association request has not been sent from the wireless station STA connected with the power output module 180. Accordingly, the CPU 110, as the process of its first prohibition module 112, ignores this association request and returns the processing to the above step S330. This process serves to prohibit completion of the automatic setting operation, based on the received association request. When the RSSI of the received association request is within the preset range (step S350: Yes), on the other hand, this means that the association request has been sent from the wireless station STA connected with the power output module 180. Accordingly, the CPU 110 registers a source MAC address of the association request into the RAM 130 (step S360). Once the MAC address is registered in this manner, the CPU 110 does not respond to any association request having a source MAC address other than the registered MAC address during this flow of automatic setting operation.

After registration of the MAC address, the CPU 110 sends an association response to the wireless station STA having the registered MAC address to establish connection with the wireless station STA (step S370). Then the CPU 110, as the process of its first execution module 111, performs the setting process as the access point (step S380). During wireless communication with the wireless station STA at step S380, the CPU 110, as the process of its first output control module 114, performs control to set the transmission output level than the output level during ordinary communication. Herein “ordinary communication” means data communication (communication of data frames) made after establishment of connection between the access point AP and the wireless station STA based on the setting information set and shared between the access point AP and the wireless station STA by the automatic setting operation. Since the access point AP and the wireless station STA have extremely proximate relative positions, the transmission output level may be set to the signal coverage of about several meters at step S380.

When completing the setting process to provide the wireless station STA with the setting information and receiving completion notice of setting the setting information from the wireless station STA, the CPU 110 lights up the LED 190 in green to notify the user of completion of setting the setting information (step S390). After such notification, the CPU 110, as the process of its first output control module 114, resets the transmission output level to the output level during ordinary communication (step S400). In other words, the reduced transmission output level is restored on completion of sharing the setting information by the setting process in this embodiment. This terminates the automatic setting operation. As discussed above, the setting process at the access point AP is triggered by detection of connection of the wireless station STA to the power output module 180. In the above embodiment, although the access point AP also starts the automatic setting operation in response to connection of an electronic device to the power output module 180, this setting process is not completed since the automatic setting operation is not performed at the wireless station STA.

### A-2-2. Automatic Setting Operation at Station

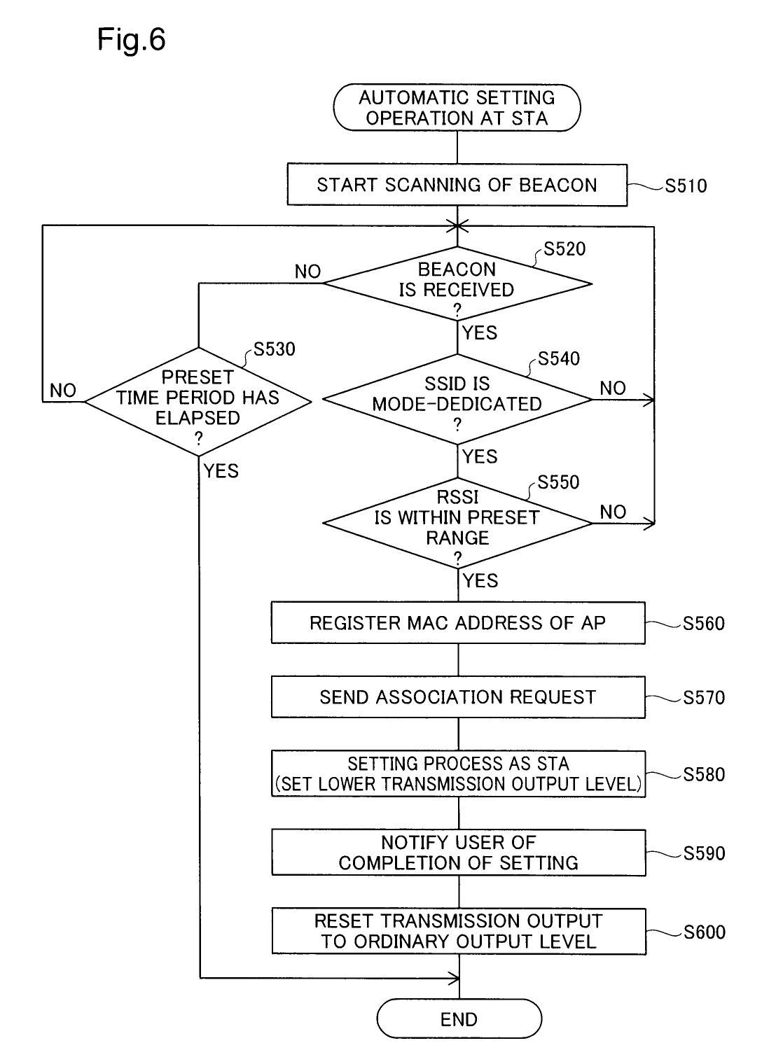

The automatic setting operation performed by the wireless station STA is explained. FIG. 6 shows the flow of automatic setting operation as the station. The automatic setting operation as the station starts when the wireless station STA is powered and activated. In this embodiment, the automatic setting operation starts when the user connects the power input module 260 of the wireless station STA to the power output module 180 of the access point AP and pushes a power button of the wireless station STA to activate the wireless station STA. Alternatively, the automatic setting operation may start when the wireless station STA receives power supply to be automatically activated by connection of the power input module 260 of the wireless station STA to the power output module 180 of the access point AP. On start of the automatic setting operation, as shown in FIG. 6, the CPU 210 of the wireless station STA first starts detection of beacon (step S510). This process searches for an access point by passive scan. Since the access point AP sends beacon at the above step S320 (FIG. 5), the wireless station STA detects the beacon sent by the access point AP. Additionally, the CPU 210 lights up the LED 290 in red on the start of detection at step S510.

After starting detection of beacon, the CPU 210 checks whether beacon is received (step S520). When the check result indicates no reception of beacon (step S520: No), the CPU 210 checks whether a preset time period has elapsed since the start of scanning of beacon (step S530). When the check result indicates elapse of the preset time period (step S530: Yes), the CPU 210 terminates the automatic setting operation. When the check result indicates no elapse of the preset time period (step S530: No), on the other hand, the CPU 210 returns the processing to the above step S520.

When the check result indicates reception of beacon (step S520: Yes), on the other hand, the CPU 210 checks whether an SSID included in the detected beacon is the dedicated SSID to the association request standby mode (step S540). When the check result indicates no dedicated SSID (step S540: No), it is identified that the access point sending the beacon is not the access point shifted to the association request standby mode as the pairing partner of the wireless station STA. Accordingly the CPU 210, as the process of its second prohibition module 212, ignores this beacon and returns the processing to the above step S520. This process serves to prohibit completion of the setting process discussed below.

When the detected beacon includes the dedicated SSID (step S540: Yes), on the other hand, this means that the source of the beacon is the access point shifted to the association request standby mode. Accordingly, the CPU 210 further checks whether the RSSI of the received beacon including the dedicated SSID is within a preset range (step S550). This identifies whether the received beacon has been sent by the access point AP connected with the power input module 260 of the wireless station STA, i.e., the access point AP as the pairing partner. Such identification is based on the same idea as that of the above step S350.

In this embodiment, “within a preset range” means “not less than a preset value”. In other words, when the RSSI is not less than the preset value, it is identified that the received beacon has been sent from the access point AP connected with the power input module 260. This effectively eliminates the beacon sent by an access point other than the access point AP. For example, even when a start instruction of the AOSS operation is given to the user's unintended access point located in signal coverage, for example, a third entity's access point, immediately after the start of the automatic setting operation at the wireless station STA, the structure of the embodiment eliminates the beacon including a spoofing dedicated-SSID sent by the third entity's access point.

When the RSSI of the received beacon is not within the preset range (step S550: No), this means that the beacon has not been sent from the access point AP connected with the power input module 260. Accordingly, the CPU 210, as the process of its second prohibition module 212, ignores this beacon and returns the processing to the above step S520. This process serves to prohibit completion of the setting process discussed below. When the RSSI of the received beacon is within the preset range (step S550: Yes), on the other hand, this means that the beacon has been sent from the access point AP connected with the power input module 260. Accordingly, the CPU 210 registers a source MAC address of the beacon into the RAM 230 (step S560). Once the MAC address is registered in this manner, the CPU 210 does not send any association request having a destination MAC address other than the registered MAC address during this flow of automatic setting operation.

After registration of the MAC address, the CPU 210 sends an association request to the access point AP having the registered MAC address to establish connection with the access point AP (step S570). Then the CPU 210, as the process of its second execution module 211, performs the setting process as the station (step S580). During wireless communication with the access point AP at step S580, the CPU 210, as the process of its second output control module 213, performs control to set lower transmission output level than the output level during ordinary communication. Such reduction of the transmission output level is based on the same idea as that of the above step S380. At step S580, the CPU 210 completes the setting process to set the setting information in the wireless station STA. In this embodiment, the CPU 210 stores and sets the setting information into the flash ROM 220 as a nonvolatile memory.

When the setting information has been set in the wireless station STA, the CPU 210 lights up the LED 290 in green to notify the user of completion of setting the setting information (step S590). After such notification, the CPU 210, as the process of its second output control module 213, resets the transmission output level to the output level during ordinary communication (step S600). In other words, the wireless station STA restores the reduced transmission output level on completion of sharing the setting information by the setting process in this embodiment. This terminates the automatic setting operation. As discussed above, the automatic setting operation at the wireless station STA is triggered by activation of the wireless station STA by power supply via the access point AP. In the above embodiment, although the wireless station STA also starts the automatic setting operation in response to activation of the wireless station STA by connection of the power input module 260 to commercial power source, this setting process is not completed since the automatic setting operation is not performed at the access point AP.

When the setting information has been set in the wireless station STA as described above, the user once powers off the wireless station STA, disconnects the wireless station STA from the access point AP, places the wireless station STA at any intended location and powers on the wireless station STA again. This enables the CPU 210 of the wireless station STA to read out the setting information stored in the flash ROM 220 and make communication with the access point AP. The access point AP may similarly be moved to another location.

### A-3. Effects

The wireless LAN system 20 is configured to enable the access point AP and the wireless station STA to perform the setting process for sharing the setting information for wireless LAN communication by utilizing the part of AOSS process. The access point AP includes the power input module 160 for receiving the input power supply and the power output module 180 for outputting the power supply to the wireless station STA and makes wireless communication with the wireless station STA in response to detection of connection of the wireless station STA to the power output module 180 to perform the setting process as the access point, which is one relevant entity of the setting process. The wireless station STA, on the other hand, makes wireless communication with the access point AP in response to activation of the wireless station STA by the input power supply to perform the setting process as the station, which is the other relevant entity of the setting process. Accordingly, only when the user connects the wireless station STA to the power output module 180 to the active access point AP to activate the wireless station STA, the setting process is performed by the access point AP and the wireless station STA to automatically share the setting information between the access point AP and the wireless station STA. In other words, since the user is only required to perform the power-on of the access point AP and the wireless station STA for automatic communication setting, the user's convenience for communication setting is improved.

Additionally, in the wireless LAN system 20, the wireless station STA sends an association request for establishing connection for wireless communication to the access point AP, before performing the setting process as the station. The access point AP then receives this association request and prohibits completion of the automatic setting operation as the access point when the RSSI of the received association request is not within a preset range, so that this suppresses completion of the setting process between the access point AP and a communication device apart from the access point AP by at least a predetermined distance, i.e., a station disconnected from the power output module 180. As the result, this suppresses the setting information from being shared between the access point AP and the user's unintended wireless device and improves the security.

Also, in the wireless LAN system 20, since the access point AP makes wireless communication with reducing the transmission output level from the output level for ordinary wireless communication during the setting process (step S380 in FIG. 5), the signal coverage for wireless communication involved in the setting process is limited. Accordingly, this suppresses completion of the setting process between the access point AP and a communication device apart from the access point AP by at least a predetermined distance, i.e., a station which is not connected to the power output module 180. As the result, this suppresses the setting information from being shared between the access point AP and the user's unintended wireless device and improves the security.

Also, in the wireless LAN system 20, since the wireless station STA makes wireless communication with reducing the transmission output level from the output level for ordinary wireless communication during the setting process (step S580 in FIG. 6), the signal coverage for wireless communication involved in the setting process is limited. Accordingly, this suppresses the setting process from being performed between the wireless station STA and a communication device apart from the wireless station STA by at least a predetermined distance, i.e., an access point other than the access point AP supplying power to the wireless station STA. As the result, this suppresses the setting information from being shared between the wireless station STA and the user's unintended access point.

Additionally, in the wireless LAN system 20, the access point AP resets the reduced transmission output level to the output level during ordinary communication when the setting process is completed to share the setting information. Similarly, the wireless station STA resets the reduced transmission output level to the output level during ordinary communication when the setting process is completed to share the setting information. Accordingly, even when the user moves and places the access point AP or the wireless station STA to the user's intended location after sharing the setting information to make a relatively large distance between the access point AP and the wireless station STA, communication can be made at the adequate transmission output level.

Also, in the wireless LAN system 20, the access point AP sends a notification frame for notifying the presence of the access point AP, before performing the setting process. The wireless station STA then receives the notification frame and prohibits completion of the setting process as the station when the RSSI of the received notification frame is not within a preset range. Accordingly, this suppresses the setting process from being performed between the wireless station STA and a communication device apart from the wireless station STA by at least a predetermined distance, i.e., an access point other than the access point AP supplying power to the wireless station STA. As the result, this suppresses the setting information from being shared between the wireless station STA and the user's unintended access point. Furthermore, since the access point AP sends beacon specified by the IEEE802.11 standard as the notification frame, the structure of the access point AP is simple.

Also, in the wireless LAN system 20, the access point AP sends beacon including a dedicated SSID to the association request standby mode for the automatic setting operation. The wireless station STA then receives this beacon and prohibits completion of the setting process as the station when the received beacon does not include the dedicated SSID, regardless of the fact that the RSSI of the received notification frame is within the present range. Accordingly, even when an access point located proximate to the wireless station STA sends beacon, this suppresses the setting information from being shared between the wireless station STA and an unintended access point as one relevant entity of the setting process.

### B. Modifications

Modified examples of the above embodiment are described.

### B-1. Modified Example 1

Although the power input module 260 is illustrated to have only the power plug protruded from the casing of the wireless station STA in the above embodiment, the power input module 260 may be provided as a power connector having a power plug at one end of a cable extended from the casing. Alternatively, the power input module 260 may not directly have a power plug. For example, the power input module 260 may be provided as a connection connector that is connectable with one end of a power cable having a power plug at only the other end or may be a connection connector that is connectable with a removable power connector having a power plug. In connection of the access point AP with the wireless station STA via a cable, using a short cable is preferable. This reduces the distance between the access point AP and the wireless station STA during the automatic setting operation and improves the accuracy of checks at the above steps S350 and S550. Additionally, the smaller distance allows for further reduction of the transmission output level at the above steps S380 and S580 and enhances the advantageous effect of suppressing completion of the setting process between wrong pairing partners. The distance between the access point AP and the wireless station STA during the automatic setting operation may be, for example, not greater than about 50 cm and more specifically not greater than about 10 cm.

### B-2. Modified Example 2

The above embodiment describes the automatic setting operation when the wireless LAN system 20 is newly established by the access point AP and the wireless station STA. The automatic setting operation is obviously applicable to newly adding a communication device to the existing wireless LAN system 20 or replacing a communication device. For example, the power input module 260 of a newly added wireless station STA may be connected to the power output module 180 of an existing access point AP, so that the automatic setting operation may be performed by the existing access point AP and the newly added wireless station STA. In this case, the access point AP may provide the newly added wireless station STA with setting information including the information of the same contents, e.g., EESID and encryption method, as the setting information provided to the existing wireless station STA by the previously performed automatic setting operation. It is thus not required to update communication settings for each of the communication devices consisting of the wireless LAN system 20.

Alternatively, when an access point AP having the access point function and the station function is newly added for relaying communication packets between access points by WDS (Wireless Distribution System), the automatic setting operation may be performed by the station function of the newly added access point AP and the existing access point AP. The newly added access point AP can thus be provided with setting information including the information of the same contents as the setting information provided to the existing wireless station STA. As the result, even when either the existing access point AP or the newly added access point AP causes communication failure, wireless packets can be relayed via a relay route excluding the failed access point AP.

### B-3. Modified Example 3

In the above embodiment, the access point AP starts the automatic setting operation in response to connection of another device to the power output module 180. The wireless station STA, on the other hand, starts the automatic setting operation in response to its activation with the received power supply. The access point AP and the wireless station STA may, however, include approval-receiving module for receiving approval or disapproval of the automatic setting operation. For example, the access point AP or the wireless station STA may have a dip switch for receiving the approval or disapproval and may start the automatic setting operation at the above timing only when the dip switch is set to “approval”. The approval-receiving module is not limited to the switch, but the access point AP or the wireless station STA may have a display and open a GUI (Graphical User Interface) on the display. Alternatively, the approval or disapproval of the automatic setting operation may be received via a WEB browser. This allows for omission of the automatic setting operation when the user does not intend the access point AP or the wireless station STA to perform the automatic setting operation, thus improving the efficiency of processing.

Like the detection circuit 170 of the access point AP, the wireless station STA may have a detection circuit or a detection module for detecting external connection to the power input module 260. In this case, the wireless station STA may start the automatic setting operation in response to detection of external connection to the power input module 260, instead of starting the automatic setting operation in response to its activation with the received power supply.

### B-4. Modified Example 4

The access point AP and the wireless station STA described above may not exclude the configuration of performing the conventional AOSS-based setting operation. For example, the access point AP and the wireless station STA may additionally have the AOSS function for receiving an instruction via the push of an AOSS button or via a WEB browser to start the setting operation. This increases the number of the user's operational options for the setting operation, thus improving the user's convenience.

### B-5. Modified Example 5

The access point AP and the wireless station STA described above may be configured to allow for connection of the power output module 180 with the power input module 260 with regard to only one or a plurality of combinations of one or plural particular types of access points AP and one or plural particular types of wireless stations STA. This configuration may be implemented, for example, by providing at least one of the access point AP and the wireless station STA with a partially protruding shape and the other with a shape for receiving the protruding shape. More specifically, for example, the power output module 180 may have a predetermined convex, and the power input module 260 may have a concave engaging with the convex at a corresponding position. The convex of this structure interferes with connection of a conventional power plug included in a device other than the wireless station STA to the power output module 180. Accordingly, since only the power input module 260 is connectable with the power output module 180, this prevents connection of any unintended device to the access point AP to start the automatic setting operation at the access point AP. The power input module 260 of this structure merely has the concave and is connectable with another socket, so that there is no unnecessary limitation in use of the wireless station STA. Such protruding shape or receiving shape may be provided on the power output module 180 or the power input module 260. Alternatively, the protruding shape or the receiving shape may be provided on a face having the power output module 180 or the power input module 260 among the faces of the casing of the access point AP or the wireless station STA.

Additionally, at least one of the access point AP and the wireless station STA may be configured to recognize a device compliant to the automatic setting operation described above, when the power output module 180 is connected with the power input module 260. The automatic setting operation may then be performed only when connection of the compliant device is recognized. This configuration may be implemented, for example, by detecting the reception of the protruding shape into the receiving shape by a mechanical method or an optical method. Alternatively, connection of a device compliant to the automatic setting operation may be detected electrically by, for example, RFID (Radio Frequency Identification). This prevents the automatic setting operation from starting against the user's intention, for example, when an electronic device is simply connected to the power output module 180 or when the power input module 260 is directly connected with commercial power source, thus improving the efficiency of process.

### B-6. Modified Example 6

In the embodiment described above, the access point AP and the wireless station STA set lower transmission output level during wireless communication for the setting process than the output level during ordinary communication and reset the reduced transmission output level on completion of sharing the setting information by the setting process. Since the access point AP and the wireless station STA are wireless communication devices, connection of the power output module 180 of the access point AP with the power input module 260 of the wireless station STA is only for the purpose of sharing the setting information, and the access point AP and the wireless station STA are expected to be used at separate locations after completion of sharing the setting information. Accordingly, the moment of completion of sharing the setting information can be regarded as timing when the access point AP and/or the wireless station STA is expected to move to an intended location. The transmission output level of the access point AP and/or the wireless station STA may thus be restored to the output level during ordinary communication at the “timing when moving to an intended location is expected”.

Any of various specific moments other than the above example may be regarded as the timing when moving to the location is expected. For example, the moment when sharing the setting information is completed and the wireless station STA is once powered off and subsequently powered on again may be regarded as the “timing when moving to the location is expected”. When the wireless station STA is powered on again, there is high possibility that the wireless station STA is placed at an intended location. Alternatively, the moment when sharing the setting information is completed and it is detected that the RSSI of a communication packet, for example, beacon, received from the access point AP is not higher than a preset value may be regarded as the “timing when moving to the location is expected”. The RSSI of not higher than the preset value means that the access point AP and/or the wireless station STA is moved to increase the distance between the access point AP and the wireless station STA. Any of these configurations also allows for wireless communication, since the transmission output level is restored when the access point AP and the wireless station STA establish a connection based on the shared setting information to transfer data frames.

Alternatively, the moment when the access point AP detects detachment of the wireless station STA from the power output module 180 may be regarded as the “timing when moving to the location is expected”. The access point AP can readily detect the detachment of the wireless station STA by means of its detection circuit 170. This configuration also ensures the above advantageous effects. Additionally, the reduced transmission output level continues immediately before the user's actual shift of the access point AP and/or the wireless station STA, so that the time period when the access point AP sends beacon with the reduced transmission output level is relatively elongated. No beacon is required between the access point AP and the wireless station STA until the access point AP and/or the wireless station STA is moved to the intended location. Accordingly, this configuration can reduce the power consumption of the access point AP required for transmission of beacon without affecting communication between the access point AP and the wireless station STA.

### B-7. Modified Example 7

Although the Ethernet converter is shown as the wireless station STA in the above embodiment, the wireless station STA is not specifically limited but may be any communication device with the station function. One example of such communication device is PDA (Personal Digital Assistant). Additionally, the access point AP and/or the wireless station STA may be mounted on various electronic devices. Alternatively, the access point AP and/or the wireless station STA may be a wireless communication adapter connectable with various home appliances to provide the home appliances with wireless communication function.

### B-8. Modified Example 8

Although the access point AP is configured to have the power output module 180 in the above embodiment, the wireless station STA may be configured to have a power output module. In this case, the wireless station STA may perform the setting process in response to detection of connection to the power output module, while the access point AP may perform the setting process in response to its activation with the received power supply.

### B-9. Modified Example 9

Although the part of the AOSS protocol is used as the protocol for implementing the setting process in the above embodiment, the protocol is not specifically limited but may be, for example, WPS. Additionally, the protocol used may not be limited to the protocol for asymmetric processing between the access point and the station. For example, the protocol used may be a protocol performed between wireless communication devices having definition of asymmetric positions, such as a master-slave relation. Alternatively, when a protocol performed between two stations is developed, the invention may be applied to this protocol.

### B-10. Modified Example 10

In the above embodiment, the automatic setting operation starts when the two communication devices are interconnected via the power line (power socket/plug). Alternatively, the automatic setting operation may start when the two communication devices are interconnected via wired connectors other than the power line. Available examples of such wired connectors include USB connectors and Ethernet connectors. The application using the wired connectors other than the power line ensures the similar advantageous effects to those of the above embodiment and modified examples. Additionally, any of the various modified examples described above may be applied for the wired connectors other than the power line. Connectors allowing for power supply are, however, desirable for the wired connectors. The power can then be supplied from the first communication device to the second communication device via such wired connectors, so that there is no need of connecting another power source with the second communication device. In an application interconnecting two communication devices via wired connectors that do not supply power, it is desirable to provide each of the two communication devices with a detection circuit (detection module) for detecting connection of another wired connector to its wired connector.

While the invention has been described with the embodiment of the invention, among the various elements of the invention included in the above embodiment, those other than the elements disclosed in independent claims are additional and supplementary elements and may be omitted or combined according to the requirements. Additionally, the invention is not limited to the above embodiment but may be actualized in diversity of other embodiments and applications within the scope of the invention. For example, the invention may be actualized by a method of sharing setting information, a program of the method or a storage medium in which the program is recorded, in addition to the wireless LAN system and the communication device.

1. A wireless Local Area Network (LAN) system including comprising a first communication device having a first wired connector, and a second communication device having a second wired connector connectable with the first wired connector, the wireless LAN system being configured to enable a setting process, performed between the first communication device and the second communication device, for sharing setting information including information for settings of wireless communication,
the first communication device comprising:
a first wireless LAN interface; and
a first execution module that controls wireless communication with the second communication device and performs a first operation as the first communication device's operation of the setting process when the second wired connector is connected to the first wired connector,
the second communication device comprising:
a second wireless LAN interface; and
a second execution module that controls wireless communication with the first communication device and performs a second operation as the second communication device's operation of the setting process when the first wired connector is connected to the second wired connector.

2. The wireless LAN system according to claim 1, wherein
the first wired connector is a power socket,
the second wired connector is a power plug, and
the first communication device further comprises:
a power input module that receives input of power supply as power for the first communication device;
a power output module that outputs power to the second communication device via the power socket; and
a detection module that detects connection of the power plug to the power socket, wherein
the first execution module performs the first operation when the connection of the power plug to the power socket is detected, and
the second execution module performs the second operation when the second communication device is activated with power received from the power output module via the power socket.

3. The wireless LAN system according to claim 1, wherein
the second execution module sends an association request for establishing a wireless connection to the first communication device before performing the second operation, and
the first communication device further comprises a first prohibition module for that prohibits completion of the first operation with a source of the association request when a received signal strength indication of the received association request is not within a preset range.

4. The wireless LAN system according to claim 1, wherein
the first communication device further comprises a first output control module that controls a transmission output level of the first wireless LAN interface, and
the first output control module sets a lower transmission output level than an output level during ordinary wireless communication with the second communication device when the first communication device performs wireless communication as the first operation.

5. The wireless LAN system according to claim 4, wherein
the first output control module resets the transmission output level of the first communication device to the output level during ordinary communication, at timing when at least one of the first communication device and the second communication device sharing the setting information is expected to be moved to an intended location.

6. The wireless LAN system according to claim 1, wherein
the second communication device further comprises a second output control module that controls a transmission output level of the second wireless LAN interface, and
the second output control module sets a lower transmission output level than an output level during ordinary wireless communication with the first communication device when the second communication device performs wireless communication as the second operation.

7. The wireless LAN system according to claim 6, wherein
the second output control module resets the transmission output level of the second communication device to the output level during ordinary communication, at timing when at least one of the first communication device and the second communication device sharing the setting information is expected to be moved to an intended location.

8. The wireless LAN system according to claim 1, wherein
the first communication device further comprises a notification module that sends a notification frame for notifying presence of the first communication device before performing the first operation, and
the second communication device further comprises a second prohibition module that prohibits completion of the second operation with a source of the notification frame when a received signal strength indication of the received notification frame is not within a preset range.

9. The wireless LAN system according to claim 8, wherein
the notification module sends the notification frame including specified identification information, and
the second prohibition module prohibits completion of the second operation with the source of the received notification when the received notification frame does not include the identification information even when the received signal strength indication of the received notification frame is within the preset range.

10. A communication device configured to enable a setting process, performed with another communication device, for sharing setting information including information for settings of wireless communication to another communication device, the communication device comprising:
a wireless LAN interface;
a first wired connector; and
an execution module that controls wireless communication with the another communication device and performs the first communication device's operation of the setting process when a second wired connector of the another communication device is connected to the first wired connector.

11. The communication device according to claim 10, wherein
the first wired connector is a power socket, and
the second wired connector is a power plug,
the communication device further comprising:
a power input module that receives input of power supply as power for the communication device;
a power output module that outputs power to the another communication device via the power socket; and
a detection module that detects connection of the power plug to the power socket, wherein
the execution module performs the operation of the setting process when the connection of the power plug to the power socket is detected.

12. The communication device according to claim 10, further comprising:
a prohibition module that prohibits completion of the operation of the setting process with a source of an association request when a received signal strength indication of the received association request is not within a preset range.

13. The communication device according to claim 10, further comprising:
an output control module that controls a transmission output level of the wireless LAN interface, wherein
the output control module sets a lower transmission output level than an output level during ordinary wireless communication for making data communication with the another communication device when the communication device performs wireless communication as the operation of the setting process.

14. A communication device configured to enable a setting process, performed with another communication device, for sharing setting information including information for settings of wireless communication to another communication device, the communication device comprising:
a wireless LAN interface;
a wired connector; and
an execution module that controls wireless communication with the another communication device and performs the communication device's operation of the setting process when a connector of the another communication device is connected to the wired connector.

15. The communication device according to claim 14, wherein
the execution module performs the operation of the setting process when the communication device receives power supply via the wired connector and is activated.

16. The communication device according to claim 14, further comprising:
an output control module that controls a transmission output level of the wireless LAN interface, wherein
the output control module sets lower transmission output level than an output level during ordinary communication for making data communication with the another communication device, when the communication device performs wireless communication as the one relevant entity's operation of the setting process.

17. The communication device according to claim 14, further comprising:
a prohibition module that prohibits completion of the operation of the setting process with a source of a notification frame when a received signal strength indication of the received notification frame is not within a preset range.

18. A method of performing a setting process for sharing setting information including information for settings of wireless communication between a first communication device having a first wired connector and a second communication device having a second wired connector connectable with the first wired connector, the method comprising:
the first communication device performing a first operation of the setting process when the second wired connector is connected to the first wired connector; and
the second communication device performing a second operation of the setting process when the first wired connector is connected to the second wired connector.

19. The method according to claim 18, wherein
the first communication device has a power output module that externally outputs power supply via the first wired connector, and
the second communication device performs the second operation when the second communication is activated with the power supply output from the first communication device via the first and second wired connectors.
